(19) United States
(12) Patent Application Publication
(10) Pub. No.: US 2016/0125044 A1
(43) Pub. Date: May 5, 2016

(54) Automatic Data Display Selection

(71) Applicant: Navico Holding AS, Egersund (NO)

(72) Inventors: Jeremiah Clark, Tulsa, OK (US); Stephen Wilson, Petersfield (GB)

(21) Appl. No.: 14/531,855

(22) Filed: Nov. 3, 2014

(51) Int. Cl. G06F 17/30

(52) U.S. Cl. CPC G06F 17/30554; G06F 17/30386

(57) ABSTRACT

Various implementations described herein are directed to a non-transitory computer readable medium having stored thereon computer-executable instructions which, when executed by a computer, may cause the computer to receive a number of display fields. The computer may retrieve a list of data types that correspond to marine electronics. The computer may also fill the number of display fields on a display with data corresponding to the list of data types. Data may only displayed if a sensor transmitting the data is detected on a network.

### RELATED APPLICATIONS

This application is related to commonly owned U.S. patent application Ser. No. ______, filed on the same day as the present application and titled REDUCED SIZE TACHOMETER DISPLAY, the entire disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Operators of marine vessels may use gauges or displays to monitor information while operating a vessel. A gauge or display may be used to display engine information, vessel speed, location, maps or charts, heading, fuel levels, trim information, or other data relevant to a vessel operator.

### SUMMARY

Described herein are implementations of various technologies for displaying marine electronics data. In one implementation, a non-transitory computer-readable medium having stored thereon computer-executable instructions which, when executed by a computer, cause the computer to perform various actions. The actions may include retrieving a hierarchical list of data items that correspond to marine electronics data. The actions may include selecting a first data item from the list of data items. The actions may include detecting whether data corresponding to the first data item is available on a network. The actions may also include displaying data corresponding to the first data item if data corresponding to the first data item is available on the network.

Described herein are also implementations of various technologies for displaying marine electronics data using priority. In one implementation, a non-transitory computer-readable medium having stored thereon computer-executable instructions which, when executed by a computer, cause the computer to perform various actions. The actions may include retrieving a hierarchical list of data items that correspond to marine electronics data. The actions may include selecting a first data item from the list of data items. The first data item has the highest priority in the list. The actions may include determining whether data corresponding to the first data item is detected. The actions may include displaying data corresponding to the first data item if data corresponding to the first data item is detected. The actions may include selecting a second data item from the hierarchy. The second data item has a lower priority than the first data item. The actions may include determining whether data corresponding to the second data item is detected. The actions may also include displaying data corresponding to the second data item if data corresponding to the second data item is detected.

Described herein are also implementations of various technologies for filling display fields on a display. In one implementation, a non-transitory computer-readable medium having stored thereon computer-executable instructions which, when executed by a computer, cause the computer to perform various actions. The actions may include receiving a number of display fields. The actions may include retrieving a list of data types that correspond to marine electronics. The actions may also include filling the number of display fields on a display with data corresponding to the list of data types. Data is only displayed if a sensor transmitting the data is detected on a network.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 is a block diagram of a vessel in accordance with implementations of various techniques described herein.

FIG. 2 is an illustration of a display device in accordance with implementations of various techniques described herein.

FIG. 3 is a flow diagram of a method for automatically selecting data for display in accordance with implementations of various techniques described herein.

FIG. 4 is a data item hierarchy in accordance with implementations of various techniques described herein.

FIG. 5 is an illustration of a marine data display in accordance with implementations of various techniques described herein.

FIG. 6 illustrates a schematic diagram of a computing system in which the various technologies described herein may be incorporated and practiced.

### DETAILED DESCRIPTION

### I. Vessel

Many vessels are equipped with a variety of sensors and instruments such as navigation systems, sonar systems, and sensors for an engine. Sensors and any other electronic devices, such as a gauge, may be connected to a network bus and may transmit or receive information using the network bus. Examples of a sensor may include any device, electrical, mechanical, chemical, or any combination thereof, that measures marine data. A gauge may be a device used to view marine data. For example, a gauge may display the speed of a vessel and the revolutions per minute (RPM) of a motor attached to the vessel. Sensors, gauges, and other electrical devices may be connected to the network bus, or networked, using a direct physical connection or a wireless link. Additionally, standardized protocols may be used for communication between the networked devices. For example, the National Marine Electronics Association (NMEA) 2000 protocol or variations of the NMEA 2000 protocol may be used for communication between sensors and a gauge on a marine vessel. In another example, the Society of Automotive Engineers J1939 protocol may be used for communication between an inboard gasoline and diesel engine and a gauge on a marine vessel.

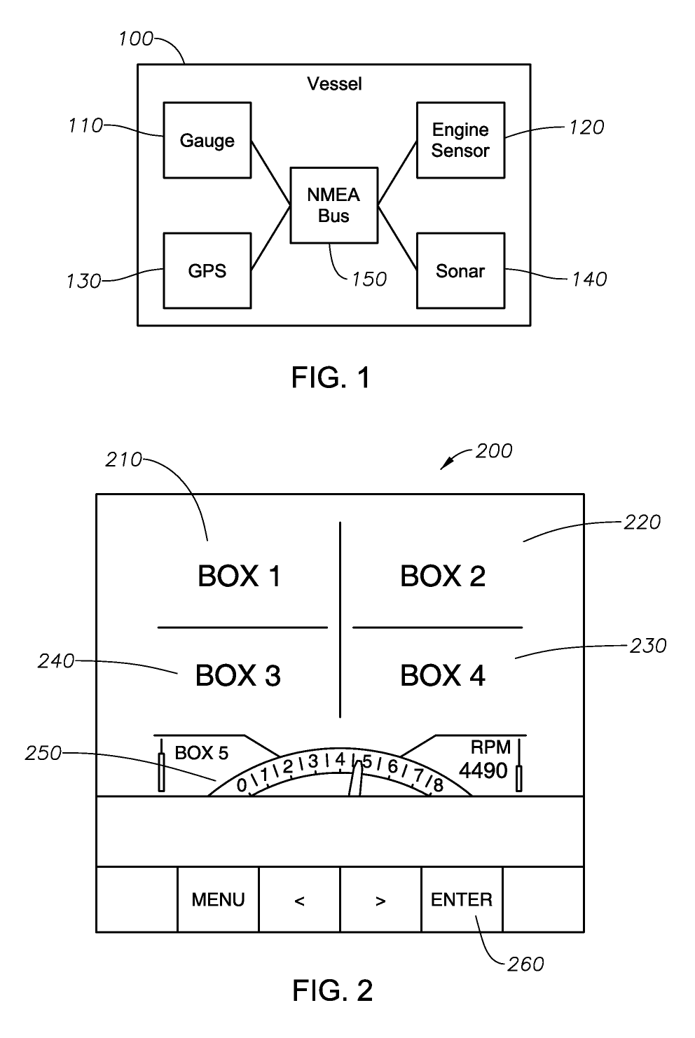

FIG. 1 is a block diagram of vessel 100 in accordance with implementations of various techniques described herein. The vessel 100 may include a gauge 110 that displays data. For example, the gauge 110 may display a speed of the vessel and a revolutions per minute (RPM) of the vessel's motor. Many vessels 100 are powered by one or more engine(s). Accordingly, the vessel 100 may include an engine sensor 120 that may monitor conditions in the engine, such as, but not limited to, temperature, pressure, fuel information, general engine and diagnostic information, and engine RPMs. The vessel 100 may include a Global Positioning System (GPS) 130 that may be used to determine the position, heading, or speed of the vessel 100. Additionally, the vessel 100 may include a sonar 140 that provides an underwater survey beneath the vessel 100. For example, the sonar 140 may be used to determine the depth of the water beneath the vessel 100.

The gauge 110, engine sensor 120, GPS 130, and sonar 140 may be configured to communicate data, send commands, and receive commands using the NMEA 2000 standard, or any other communication protocol, including a J1939 network, a proprietary network such as SmartCraft™, Command Link™ and Command Link Plus™, or a Bombardier Recreational Products™ Network. The gauge 110, engine sensor 120, GPS 130, and sonar 140 may each be connected to an NMEA 2000 bus 150, or any other type of network, such as Ethernet, Wireless Ethernet, or Bluetooth™. The NMEA 2000 bus 150 may transport data and commands between sensors. For example, the gauge 110 may use the NMEA 2000 bus 150 to receive and display data from the engine sensor 120, GPS 130, and sonar 140.

Although the vessel 100 is shown with a gauge 110, engine sensor 120, GPS 130, sonar 140, and NMEA 2000 bus 150, the vessel 100 may include any combination of sensors, and communication methods.

### II. Display Device

Various implementations described herein are with reference to the gauge 110, described in FIG. 1. However, it should be understood that the implementations described herein may be used in any display device or a multi-function display that displays marine data. FIG. 2 illustrates a display device 200 in accordance with implementations of various techniques described herein. The display device 200 may receive and display data compliant with or similar to the NMEA 2000 standard. For example, the display device 200 may receive and display data from one or more sensors, such as an engine sensor 120, a GPS 130, or a sonar 140, over a network bus, such as an NMEA 2000 bus 150.

The display device 200 may display data received from sensors or any other electronic equipment on the vessel 100. The data may be displayed on one or more pages, and a user may select which page is displayed. A page on the display device 200 may include a predetermined number of fields 210, 220, 230, and 240. In certain implementations, the display device 200 can be configured to always display a tachometer 250, as described in commonly owned U.S. patent application Ser. No. ______, filed on the same day as the present application and titled REDUCED SIZE TACHOMETER DISPLAY. The display device 200 may include a plurality of buttons 260. The buttons 260 may be used to select a page for the display device 200 to display. Different pages may display different types of data. For example, the display device 200 may display a fuel page, an engine page, or a motoring page.

The fields 210-240 may be populated with data items using a predetermined hierarchy. Each page displayed on the display device 200 may have an associated hierarchy used to select data items to display in the fields 210-40. For example, a first hierarchy may be used to populate a fuel page, a second hierarchy may be used to populate an engine page, and a third hierarchy may be used to populate a motoring page.

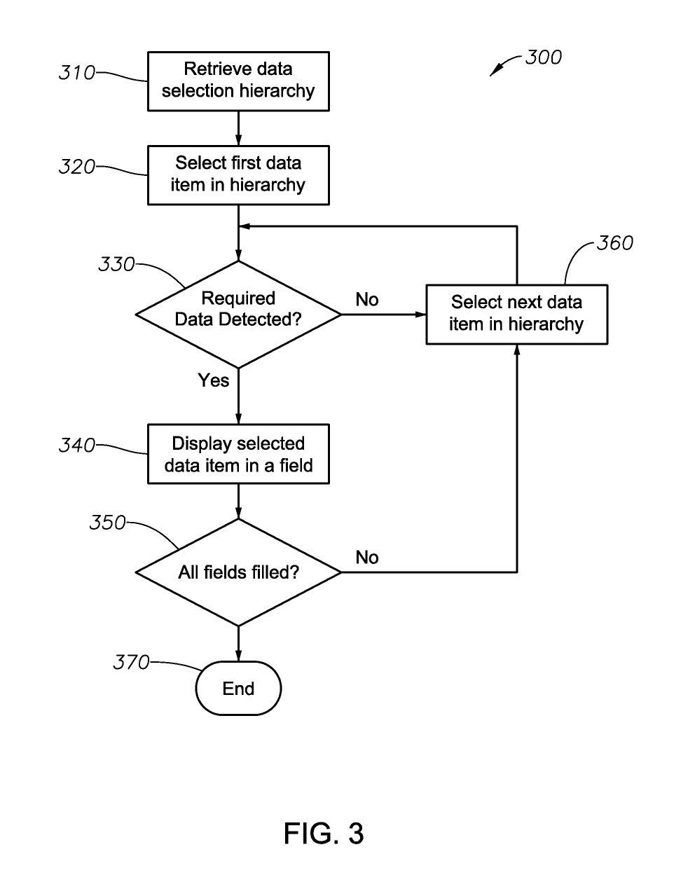

FIG. 3 is a flow chart of a method 300 for displaying data items in a hierarchy in accordance with implementations described herein. In one implementation, method 300 may be performed by any computer system 600. For example, method 300 may be performed by a computer system 600 in a gauge. It should be understood that while method 300 indicates a particular order of execution of operations, in some implementations, certain portions of the operations might be executed in a different order, and on different systems. Further, in some implementations, additional operations or steps may be added to the method 300. Likewise, some operations or steps may be omitted.

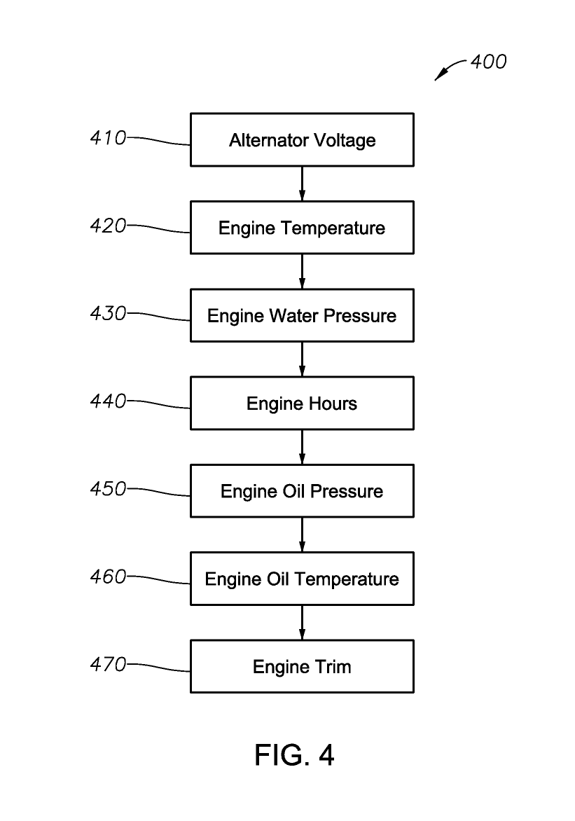

At block 310, the method may retrieve a data selection hierarchy. The data selection hierarchy may be an ordered list of data items that may be displayed on a display device. For example, the data selection hierarchy may be stored in a priority queue. FIG. 4 illustrates one example of a data selection hierarchy for an engine page. The method may also receive a number of fields to fill with display items. For example, an engine page may have three fields, and a motoring page may have four fields.

At block 320, method 300 may select a first data item in the data selection hierarchy retrieved at block 310. For example, if the data selection hierarchy is a priority queue, then the first data item retrieved would be a data item in the data selection hierarchy with the highest priority. In one implementation, one or more data items may describe a formula or instructions for calculating a data item. For example, if the data item is average speed, a formula corresponding to average speed may be retrieved with the data item.

At block 330, method 300 may determine whether data required by the data item selected at block 320 is available. For example, if the data item selected at block 320 is “vessel speed,” then method 300 may determine whether data from a GPS sensor or other speed sensor is available. In one implementation, method 300 may poll an NMEA 2000 bus on a vessel to determine whether the necessary data is available for the data item selected at block 320. In certain instances, the data item selected at block 320 may require multiple types of data. For example, if the data item selected at block 320 is fuel efficiency, then at block 330 the method may determine whether data describing distance traveled is available and whether data describing fuel usage is available. In this example, fuel efficiency may only be calculated if both types of data are available.

If method 300 detects the required data for the selected data item at block 330, then the method may continue to block 340. Alternatively, if the required data is not detected at block 330, then the method may continue to block 360. For example, if the data item selected at block 320 is speed, and a speed sensor or GPS sensor is detected at block 330, then the method may continue to block 340. In another example, if the data item selected at block 320 is engine hours, but no engine hours data is detected, then the method may continue to block 360.

At block 360, a next data item in the hierarchy retrieved at block 310 may be selected. For example, in FIG. 4, if data corresponding to the alternator voltage 410 is not detected, then the engine temperature 420 may be selected as the next data item. After selecting a new data item at block 360, the method may return to block 330 to determine whether data required for the selected item is available. For example, if the hierarchy retrieved at block 310 is the hierarchy illustrated in FIG. 4, and the next item in the hierarchy 400 is engine temperature 420, the method 300 may check at block 330 if an engine thermometer is available.

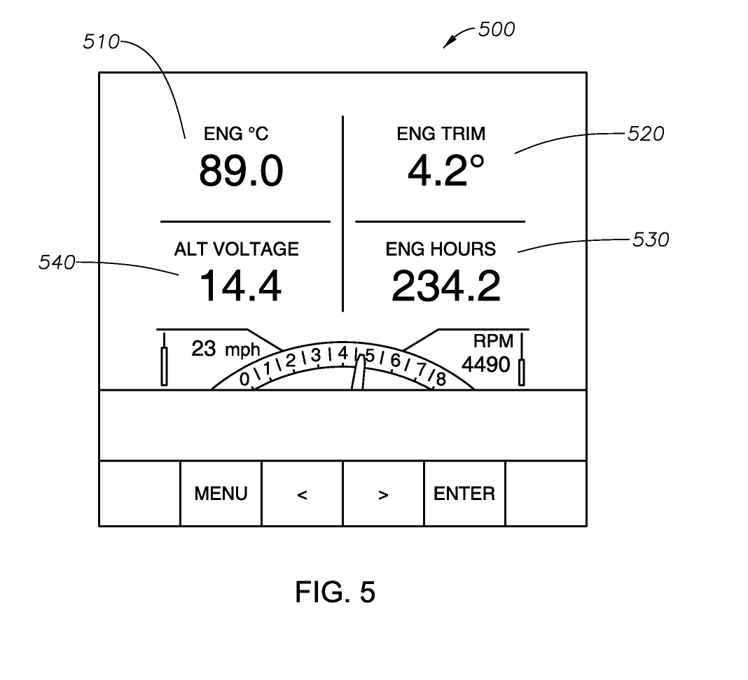

At block 340, the selected data item may be displayed or selected for display. For example, a display device 200 may display the data item in a field on a page, such as field 210, 220, 230, or 240. FIG. 5 illustrates an example of data items being displayed in fields. For purposes of this document, “display” or “displayed” shall include projecting image(s), data, or text on a screen or visual board, or outputting image(s), data, or text in a format recognized by a device that includes a screen or visual board resulting in projection of the image(s), data, or text on the screen or visual board. “Display on a display device” may include outputting an image, data, or text formatted in a format recognized by the display device for display thereon, in addition to actually displaying on the display device.

At block 350, method 300 may determine whether all fields in a page are filled. If all of the fields in a page are filled, then the method 300 may terminate at block 370. If all of the fields are not filled, then method 300 may return to block 360. For example, if a page has four fields, and only three data items have been displayed at block 340, then method 300 would select a next data item in the hierarchy at block 360. In one implementation, method 300 at block 360 may also determine whether there are any data items left in the data selection hierarchy retrieved at block 310. If no data items are left in the data selection hierarchy, then method 300 may terminate at block 350 rather than returning to block 360. In this implementation, the page may be resized to fit the reduced number of data fields.

In one implementation, method 300 may replace a data item in response to the removal or addition of a sensor or other electrical device from a network. For example, in response to removal of a sensor the method may determine whether any of the data items displayed in any of the fields are affected. If the displayed data items are affected by the removal, then method 300 may be executed again in order to display different data items. Alternatively, the affected data item or items may be replaced using blocks 320-350, without altering the unaffected data items. If a sensor or other electrical device is added to a network, then method 300 may be executed again in order to include data from the newly added sensor.

For example, if the hierarchy retrieved at block 310 is the hierarchy 400, and a sensor transmitting data describing engine water pressure 430 is added to the network, then method 300 may be executed again in order to display data from the engine water pressure 430 sensor.

FIG. 4 is a data item hierarchy 400 in accordance with implementations of various techniques described herein. The hierarchy 400 includes a data item alternator voltage 410, which has the highest priority. The availability of alternator voltage 410 may depend, for example, on whether a voltmeter or voltage data is available over a network. The data item engine temperature 420 may have the next (second) highest priority. The availability of the engine temperature 420 may depend on whether a thermometer inside the engine or temperature data is available over a network. The data item engine water pressure 430 may have the next (third) highest priority. The availability of the engine water pressure 430 may depend on whether water pressure data is available over a network. The data item engine hours 440 may have the next (fourth) highest priority. The availability of engine hours 440 may depend on whether an odometer or engine hours data is available over a network. The engine oil pressure 450 may have the next (fifth) highest priority. The availability of the engine oil pressure 450 may depend on whether a meter in an oil supply line or engine oil pressure data is available over a network. The engine oil temperature 460 may have the next (sixth) highest priority. The availability of the engine oil temperature 460 may depend on whether a thermometer in the oil supply line or engine oil temperature data is available over a network. The engine trim 470 may have the next (seventh) and lowest priority. The availability of the engine trim may depend on whether a sensor measuring the angle of an engine or engine trim data is available over a network.

It is noted that in certain implementations, the hierarchy 400 can include additional engine data items, or omit any of the engine data items 410-470, or have data items 410-470 with different priority levels.

FIG. 5 illustrates a marine data display 500 in accordance with implementations described herein. The display 500 includes fields 510, 520, 530, and 540. The display 500 may display data items from an engine data hierarchy, such as hierarchy 400, using method 300. The engine data page 500 may be displayed on a gauge or display device 200, illustrated in FIG. 2, a multi-function display, a tablet computer, a smartphone, a wearable computer, or any other electronic device on a vessel 100.

In the illustrated display, field 510 displays engine temperature 420, field 520 displays engine trim 470, field 530 displays engine hours 440, and field 540 displays alternator voltage 410. Using method 300, the fields 510-40 in the display 500 may be automatically populated with data items. Additionally, using method 300, the display 500 may automatically adjust to display data actively being transmitted on a network. For example, if data corresponding to engine trim 470 was no longer being transmitted on a network, then field 520 may automatically display a different data item.

### III. Computer System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, GPS and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

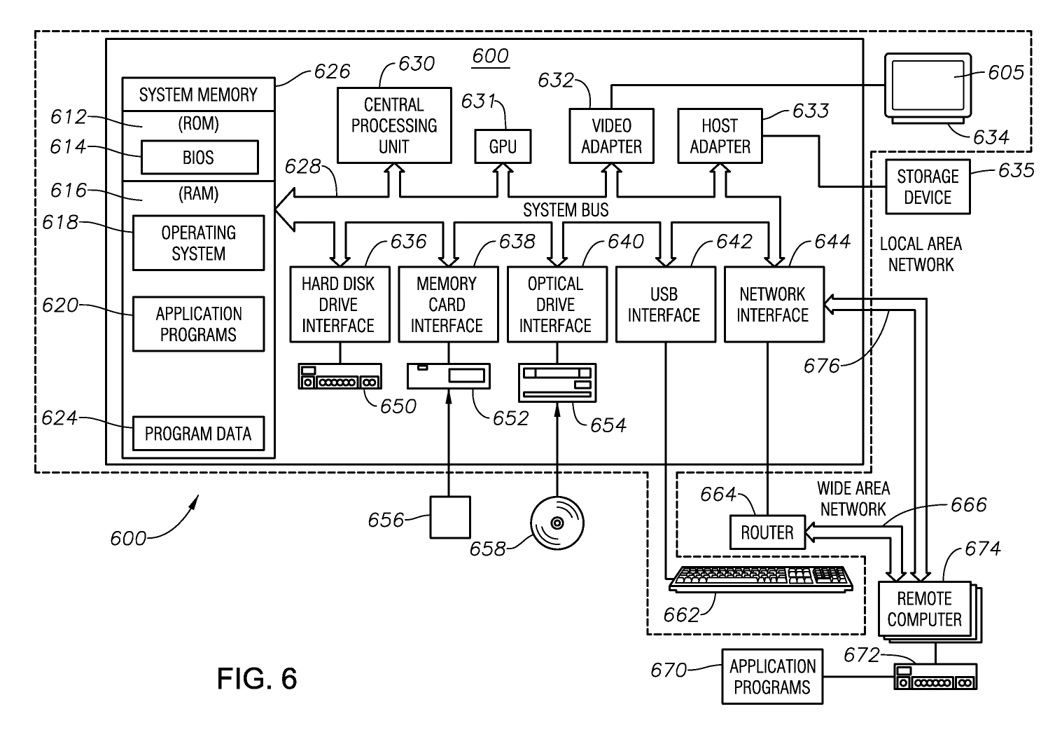

FIG. 6 illustrates a computing system 600 in accordance with implementations of various techniques described herein. Computing system 600 may be a conventional desktop, a handheld device, a wearable device, a controller, a personal digital assistant, a server computer, an electronic device/instrument, a laptop, a tablet, or part of a navigation system, marine electronics, or sonar system. It should be noted, however, that other computer system configurations may be used.

The computing system 600 may include a central processing unit (CPU) 630, a system memory 626, a graphics processing unit (GPU) 631 and a system bus 628 that couples various system components including the system memory 626 to the CPU 630. Although only one CPU 630 is illustrated in FIG. 6, it should be understood that in some implementations the computing system 600 may include more than one CPU 630.

The CPU 630 may include a microprocessor, a microcontroller, a processor, a programmable integrated circuit, or a combination thereof. The CPU 630 can comprise an off-the-shelf processor such as a Reduced Instruction Set Computer (RISC), or a Microprocessor without Interlocked Pipeline Stages (MIPS) processor, or a combination thereof. The CPU 630 may also include a proprietary processor. The CPU may include a multi-core processor.

The GPU 631 may be a microprocessor specifically designed to manipulate and implement computer graphics. The CPU 630 may offload work to the GPU 631. The GPU 631 may have its own graphics memory, and/or may have access to a portion of the system memory 626. As with the CPU 630, the GPU 631 may include one or more processing units, and each processing unit may include one or more cores.

The CPU 630 may provide output data to the GPU 631. The GPU 631 may generate graphical user interfaces that present the output data. The GPU 631 may also provide objects, such as menus, in the graphical user interface. A user may provide inputs by interacting with the objects. The GPU 631 may receive the inputs from interaction with the objects and provide the inputs to the CPU 630. A video adapter 632 may be provided to convert graphical data into signals for a monitor 634. The monitor 634 includes a screen 605. In certain implementations, the screen 605 may be sensitive to touching by a finger. In other implementations, the screen 605 may be sensitive to the body heat from the finger, a stylus, or responsive to a mouse.

The system bus 628 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. In certain implementations, the computer system 600 may be attached to an NMEA 2000 bus or network. The computer system 600 may send or receive data to or from another device attached to the NMEA 2000 bus. For example, the computer system 600 may transmit commands and receive data from a motor or a sensor using an NMEA 2000 bus. The marine electronics device 600 may transmit or receive NMEA 2000 compliant messages, messages in a proprietary format that do not interfere with NMEA 2000 compliant messages or devices, or messages in any other format. The NMEA 2000 data may be displayed using method 300.

The system memory 626 may include a read only memory (ROM) 612 and a random access memory (RAM) 616. A basic input/output system (BIOS) 614, containing the basic routines that help transfer information between elements within the computing system 600, such as during start-up, may be stored in the ROM 612. The computing system may be implemented using a printed circuit board containing various components including processing units, data storage memory, and connectors.

Certain implementations may be configured to be connected to a GPS and/or a sonar system. The GPS and/or sonar system may be connected via the network interface 444 or Universal Serial Bus (USB) interface 442. In one implementation, the computing system 400, the monitor 434, the screen 405 and buttons may be integrated into a console.

The computing system 600 may further include a hard disk drive interface 636 for reading from and writing to a hard disk 650, a memory card reader 652 for reading from and writing to a removable memory card 656, and an optical disk drive 654 for reading from and writing to a removable optical disk 658, such as a CD ROM, DVD ROM or other optical media. The hard disk 650, the memory card reader 652, and the optical disk drive 654 may be connected to the system bus 628 by a hard disk drive interface 636, a memory card reader interface 638, and an optical drive interface 640, respectively. The drives and their associated computer-readable media may provide nonvolatile storage of computer-readable instructions, data structures, program modules and other data for the computing system 600.

Although the computing system 600 is described herein as having a hard disk, a removable memory card 656 and a removable optical disk 658, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 600 may also include a host adapter 633 that connects to a storage device 635 via a small computer system interface (SCSI) bus, a Fiber Channel bus, an eSATA bus, or using any other applicable computer bus interface.

The computing system 600 can also be connected to a router 664 to establish a wide area network (WAN) 666 with one or more remote computers 674. The router 664 may be connected to the system bus 628 via a network interface 644. The remote computers 674 can also include hard disks 672 that store application programs 670.

In another implementation, the computing system 600 may also connect to the remote computers 674 via local area network (LAN) 676 or the WAN 666. When using a LAN networking environment, the computing system 600 may be connected to the LAN 676 through the network interface or adapter 644. The LAN 676 may be implemented via a wired connection or a wireless connection. The LAN 676 may be implemented using Wi-Fi™ technology, cellular technology, Bluetooth™ technology, satellite technology, or any other implementation known to those skilled in the art. The network interface 644 may also utilize remote access technologies (e.g., Remote Access Service (RAS), Virtual Private Networking (VPN), Secure Socket Layer (SSL), Layer 9 Tunneling (L2T), or any other suitable protocol). These remote access technologies may be implemented in connection with the remote computers 674. It will be appreciated that the network connections shown are exemplary and other means of establishing a communications link between the computer systems may be used.

A number of program modules may be stored on the hard disk 650, memory card 656, optical disk 658, ROM 612 or RAM 616, including an operating system 618, one or more application programs 620, and program data 624. In certain implementations, the hard disk 650 may store a database system. The database system could include, for example, recorded points. The application programs 620 may include various mobile applications (“apps”) and other applications configured to perform various methods and techniques described herein. The operating system 618 may be any suitable operating system that may control the operation of a networked personal or server computer, such as Windows® XP, Mac OS® X, Unix-variants (e.g., Linux® and BSD®), Android®, iOS®, and the like.

A user may enter commands and information into the computing system 600 through input devices such as buttons 662, which may be physical buttons, virtual buttons, or combinations thereof. Other input devices may include a microphone, a mouse, or the like (not shown). These and other input devices may be connected to the CPU 630 through a USB interface 642 coupled to system bus 628, but may be connected by other interfaces, such as a parallel port, or game port.

Certain implementations may be configured to interface to sensors in a vessel. In one implementation, the one or more application programs 620 or 670 stored in the computer-readable media can include a plurality of instructions that when executed by a processing unit, such as a CPU 630, cause the computing system to perform any of the techniques, or portions thereof, that are described herein.

The detailed description is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. Nothing in this application is considered critical or essential to the claimed invention unless explicitly indicated as being “critical” or “essential.”

Reference has been made in detail to various implementations, examples of which are illustrated in the accompanying drawings and figures. In the detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the implementations.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

“Alternatively” shall not be construed to only pertain to situations where the number of choices involved is exactly two, but rather refers to another possibility among many other possibilities.

Additionally, various technologies and techniques described herein include receiving user requests for a number of different operations. In certain instances, the user request for a particular operation will be explicitly described. It shall be understood that a “request” or “can request” shall also include, but are not limited to, touching a screen, double tapping a screen (tapping the screen twice in rapid succession), pressing a particular physical or virtual button, making a selection from a menu, swiping the screen (placing a finger towards an edge of the screen and traversing the screen while maintaining contact between the finger and the screen) placement of a cursor at a particular location, stylus pointing, mouse selection, an audible command, as well as the explicit description of the “request” for the particular operations.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer readable medium having stored thereon a plurality of computer-executable instructions which, when executed by a computer, cause the computer to:
retrieve a hierarchical list of data items that correspond to marine electronics data;
select a first data item from the list of data items;
detect whether data corresponding to the first data item is available on a network; and
display data corresponding to the first data item if data corresponding to the first data item is available on the network.

2. The non-transitory computer readable medium of claim 1 wherein the computer-executable instructions further cause the computer to display data corresponding to a second data item in the list of data items if data corresponding to the first data item is not available on the network.

3. The non-transitory computer readable medium of claim 1 wherein the computer-executable instructions that cause the computer to detect whether the data corresponding to the first data item is available on the network comprise computer-executable instructions that cause the computer to detect whether one or more sensors measuring data corresponding to the first data item are connected to the network.

4. The non-transitory computer readable medium of claim 1 wherein the computer-executable instructions that cause the computer to select a first data item from the list of date items comprise computer-executable instructions that cause the computer to select a data item with a highest priority in the list of data items.

5. The non-transitory computer readable medium of claim 1 wherein the computer-executable instructions that cause the computer to detect whether data corresponding to the first data item is available on the network comprise computer-executable instructions that cause the computer to detect whether National Marine Electronics Association (NMEA) 2000 compliant data corresponding to the first data item is available on the network.

6. The non-transitory computer readable medium of claim 1 wherein the hierarchical list of data items comprises one or more formulas or instructions for calculating a data item.

7. The non-transitory computer readable medium of claim 1 wherein the data corresponding to the first data item comprises data from a plurality of sensors.

8. The non-transitory computer readable medium of claim 1 wherein the first data item has a highest priority in the hierarchical or prioritized list.

9. The non-transitory computer readable medium of claim 1, wherein the computer-executable instructions further cause the computer to:
detect that the data corresponding to a displayed data item is not being transmitted on the network; and
automatically replace the displayed data item with another data item.

10. The non-transitory computer readable medium of claim 1, wherein the computer-executable instructions further cause the computer to:
detect that a sensor has been added to the network; and
automatically replace a displayed data item with a data item corresponding to the sensor.

11. A non-transitory computer readable medium having stored thereon a plurality of computer-executable instructions which, when executed by a computer, cause the computer to:
retrieve a hierarchical list of data items that correspond to marine electronics data;
select a first data item from the list of data items, wherein the first data item has the highest priority in the list;
determine whether data corresponding to the first data item is detected;
display data corresponding to the first data item if data corresponding to the first data item is detected;
select a second data item from the hierarchy, wherein the second data item has a lower priority than the first data item;
determine whether data corresponding to the second data item is detected; and
display data corresponding to the second data item if data corresponding to the second data item is detected.

12. The non-transitory computer readable medium of claim 11, wherein the computer-executable instructions that cause the computer to determine whether data corresponding to the first data item is detected comprise computer-executable instructions that cause the computer to detect whether one or more sensors measuring data corresponding to the first data item are connected to a network.

13. The non-transitory computer readable medium of claim 11 wherein the hierarchical or prioritized list of data items comprises one or more formulas or instructions for calculating a data item.

14. The non-transitory computer readable medium of claim 11 wherein the computer-executable instructions that cause the computer to determine whether data corresponding to the first data item is detected comprise computer-executable instructions that cause the computer to detect whether National Marine Electronics Association (NMEA) 2000 compliant data corresponding to the first data item is available on the network.

15. The non-transitory computer readable medium of claim 11, wherein the computer-executable instructions further cause the computer to:
determine that the data corresponding to the first or second data item is no longer detected; and
automatically replace the first or second data item with a third data item in the list of data items.

16. The non-transitory computer readable medium of claim 11, wherein the computer-executable instructions further cause the computer to:
detect that a sensor has been added to the network; and
automatically replace a displayed data item with a data item corresponding to the sensor.

17. A non-transitory computer readable medium having stored thereon a plurality of computer-executable instructions which, when executed by a computer, cause the computer to:
receive a number of display fields;
retrieve a list of data types that correspond to marine electronics; and
fill the number of display fields on a display with data corresponding to the list of data types, wherein data is only displayed if a sensor transmitting the data is detected on a network.

18. The non-transitory computer readable medium of claim 17 wherein the list of data types comprises a hierarchical or prioritized list of data items.

19. The non-transitory computer readable medium of claim 17 wherein the network is a National Marine Electronics Association (NMEA) 2000 bus.

20. The non-transitory computer readable medium of claim 11 wherein the number of display fields is received in response to a request to display a page.
